(19) United States
(12) Patent Application Publication
(10) Pub. No.: US 2008/0089462 A1
(43) Pub. Date: Apr. 17, 2008

(54) TIMER CIRCUIT AND SIGNAL PROCESSING CIRCUIT INCLUDING THE SAME

(75) Inventor: Shin-ichiro Tomisawa, Gifu (JP)

Correspondence Address: FISH & RICHARDSON P.C., P.O. BOX 1022, MINNEAPOLIS, MN, 55440-1022, US

(73) Assignees: SANYO ELECTRIC CO., LTD., Osaka (JP); SANYO SEMICONDUCTOR CO., LTD., Gunma (JP)

(21) Appl. No.: 11/851,201

(22) Filed: Sep. 6, 2007

(30) Foreign Application Priority Data
Oct. 2, 2006 (JP) 2006-270984

(51) Int. Cl. G06M 3/02

(52) U.S. Cl. 377/2

(57) ABSTRACT

A timer circuit for setting a reload value according to a time to be measured and carrying out count operation based on the set reload value, comprising: a memory configured to store a plurality of reload values; a reload value address generation circuit configured to generate a reload value address indicating a storage location of each of the plurality of reload values in the memory; a counter configured to carry out count operation based on the reload value read out from the memory referring to a reload value address generated in the reload value address generation circuit; and a timer control circuit configured to control update of the reload value address in the reload value address generation circuit and read-out of the reload value from the memory to the counter.

### CROSS-REFERENCE TO RELATED APPLICATION

This application claims the benefit of priority to Japanese Patent Application No. 2006-270984, filed Oct. 2, 2006, of which full contents are incorporated herein by reference.

### BACKGROUND OF THE INVENTION

1. Field of the Invention

The present invention relates to a timer circuit and a signal processing circuit provided therewith.

2. Description of the Related Art

Timer/counter circuits, which measure a predetermined period by counting edges of a clock signal, (hereinafter referred to as “timer circuit”) are variously used for generating various kinds of timing in a signal processing circuit in a microcomputer, DSP and the like. For example, in a microcomputer, a timer circuit is usually provided for timer interruption, which is a type of hardware interruption.

FIG. 12 is a diagram illustrating a configuration of a timer circuit included in a conventional microcomputer, and FIG. 13 is a diagram illustrating waveforms of major signals of the timer circuit shown in FIG. 12.

A counter 400 is included in a timer circuit that is connected to a CPU 500 and generates an interrupt request signal IRQ. That is, the counter 400 loads a reload value (count initial value) RV from the CPU 500 (See FIG. 13(c)), counts down from the reload value RV and supplies the interrupt request signal IRQ (See FIG. 13(b) to the CPU 500 at the point of time when the count value CV (See FIG. 13(a)) has become ‘0’.

When the interrupt request signal IRQ is caused to be repeatedly generated in a given cycle, the counter 400 is required to load a new reload value RV (See FIG. 13(c)) from the CPU 500 every time the counter 400 supplies the timer interrupt request IQR to the CPU 500, and to count down from the new reload value RV.

However, in the CPU 500, an interruption prohibited period is usually set since another program is being executed or the like, and therefore, the CPU 500 can not immediately respond to the interrupt request signal IRQ from the counter 400. That is, when the counter 400 repeatedly generates the interrupt request signal IRQ cyclically, a waiting time d occurs between the time when the interrupt request signal IRQ is generated and the time when the reload value RV from the CPU 500 is loaded. Since the interruption prohibited period is varied from time to time, the waiting time d is not necessarily constant and hence, the generation cycle of the interrupt request signal IRQ is not constant.

Then, in the conventional timer circuit, a reload register for storing reload values RV may be provided in order to set the reload value RV stored in the reload register in the counter (See Japanese Patent Laid-Open No. 1993-80089, for example). FIG. 14 is a diagram illustrating a configuration of a conventional timer circuit provided with a reload register, and FIG. 15 is a diagram illustrating waveforms of major signals of the timer circuit shown in FIG. 14.

A timer circuit 70 includes, in addition to the counter 400, a reload register 410 for storing a reload value RV set by the CPU 500 and a timer control circuit 420 for controlling switching of the reload value RV set by the counter 400. The counter 400 does not directly load the reload value RV from the CPU 500 after generation of the interrupt request signal IRQ, but loads the reload value RV stored in advance in the reload register 410 according to a load signal LD from a counter control unit 420 (See FIGS. 15(b) and 15(c)). As a result, the counter 400 can set the reload value RV from the reload register 410 according to the load signal LD independently of the processing by the CPU 500, and thereby the above-mentioned waiting time d does not occur, and therefore, the generation cycle of the interrupt request signal IRQ becomes a constant cycle (See FIGS. 15(a), 15(b)). (See Japanese Patent Laid-Open No. 1993-80089).

The conventional reload register has such a specification that only one type of the reload value RV can be set. Also, the reload value RV stored in the reload register is changed by software processing of the CPU. That is, as shown in FIGS. 13 and 15, the specification does not cause any trouble if there is need to cause an interrupt to occur repeatedly in a constant cycle.

However, if there is need to cause the interrupt to occur repeatedly in a non-constant cycle, it become's necessary to set a new reload value RV in the reload register every time by software processing of the CPU. Therefore, when the setting of the reload value RV is frequently changed, since the CPU sets the interruption prohibited period due to other program processing, a delay (overhead) occurs when the setting of the reload value RV is changed.

### SUMMARY OF THE INVENTION

A timer circuit, according to an aspect of the present invention, for setting a reload value according to a time to be measured and carrying out count operation based on the set reload value, comprises: a memory configured to store a plurality of reload values; a reload value address generation circuit configured to generate a reload value address indicating a storage location of each of the plurality of reload values in the memory; a counter configured to carry out count operation based on the reload value read out from the memory referring to a reload value address generated in the reload value address generation circuit; and a timer control circuit configured to control update of the reload value address in the reload value address generation circuit and read-out of the reload value from the memory to the counter.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is a diagram illustrating a configuration of a timer circuit according to a first embodiment of the present invention;

FIG. 2 is a diagram illustrating waveforms of major signals of a timer circuit according to a first embodiment of the present invention;

FIG. 3 is a diagram illustrating a configuration of a timer circuit according to a second embodiment of the present invention;

FIG. 4 is a diagram illustrating waveforms of major signals of a timer circuit according to a second embodiment of the present invention;

FIG. 5 is a diagram illustrating a configuration of a timer circuit according to a third embodiment of the present invention;

FIG. 6 is a diagram illustrating waveforms of major signals of a timer circuit according to a third embodiment of the present invention;

FIG. 7 is a diagram illustrating a configuration of a timer circuit according to a fourth embodiment of the present invention;

FIG. 8 is a diagram illustrating waveforms of major signals of a timer circuit according to a fourth embodiment of the present invention;

FIG. 9 is a diagram illustrating a configuration of a timer circuit according to a fifth embodiment of the present invention;

FIG. 10 is a diagram illustrating waveforms of major signals of a timer circuit according to a fifth embodiment of the present invention;

FIG. 11 is a diagram illustrating a configuration of an arbitrary pulse generation circuit according to the present invention;

FIG. 12 is a diagram illustrating a configuration of a timer circuit;

FIG. 13 is a diagram illustrating waveforms of major signals of a timer circuit;

FIG. 14 is a diagram illustrating a configuration of another timer circuit; and

FIG. 15 is a diagram illustrating waveforms of major signals of another timer circuit.

### DETAILED DESCRIPTION OF THE INVENTION

At least the following details will become apparent from descriptions of this specification and of the accompanying drawings.

### First Embodiment

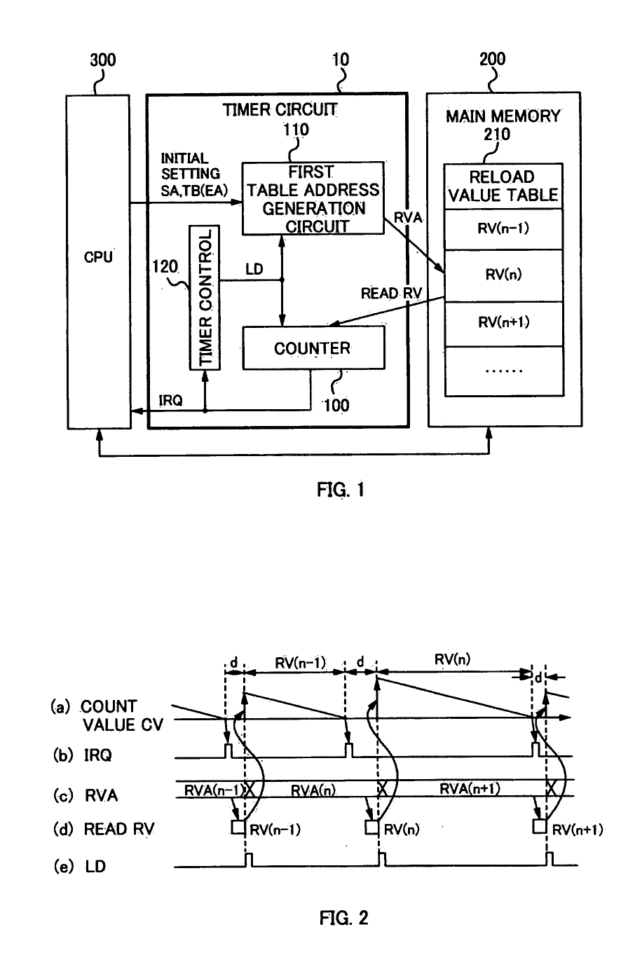

FIG. 1 is a diagram illustrating a configuration of a timer/counter circuit 10 (hereinafter referred to as “timer circuit”) included in or externally attached to a microcomputer according to a first embodiment of the present invention.

The timer circuit 10 includes a counter 100, a first table address generation circuit 110, and a timer control circuit 120, and is operated by being connected to a main memory 200 and a CPU 300 (“processor” according to the present invention).

The counter 100 is configured with a down counter which carries out down-count with a reload value RV as a count initial value and outputs an interrupt request signal IRQ and other status flags when the count value CV has become ‘0’. The counter 100 may include also an up counter or an up/down counter instead of the down counter. For example, in thee case of the up counter, an embodiment may be so constituted that up-count is carried out from ‘0’ with the reload value RV as a count final value and when the count value CV has become the reload value RV, the interrupt request signal IRQ and other status flags are output.

The first table address generation circuit 110 is an embodiment of a “reload value address generation circuit” according to the present invention and generates a reload value address RVA indicating a storage location of each of the plurality of reload values RV in the main memory 200. When described in detail, the first table address generation circuit 110 cyclically generates a reload value address RVA in the main memory 200, in which the reload value RV to be set in the counter 100 its stored, in other words, a first table address RVA of a reload value table 210, which will be described later, stored in the main memory 260.

In the first table address generation circuit 110, a table start address SA and a table size TB or a table end address EA in the reload value table 210 are initially set by the CPU 300. As a result, the first table address generation circuit 110 can recognize the location and the size of the reload value table 210 in the main memory 200, and by incrementing/decrementing the address by an entry size from the table start address SA to the table end address EA, for example, the reload value address RVA is cyclically generated.

The first table address generation circuit 110 determines if the reload value address RVA generated by itself exceeds an address setting range of the reload value table 210 or not, and if the address setting range exceeds the address setting range, the count operation by the counter 100 is finished or the count operation by the counter 100 is continued after the generated reload value address RVA is reset to an initial value (table start address SA, or table end address EA) That is, even if the reload value address RVA exceeds the address setting range of the reload value table 210, the count operation by the counter 100 can be automatically finished so that the counter 100 can be used constantly.

Moreover, if the contents of the table start address SA or the like set by the CPU 300 or the contents of the reload value address RVA generated by itself become an invalid address such as all-0, all-1, an odd-byte address or an address beyond management targets of the, main memory 200, the first table address generation circuit 110 finishes the count operation by the counter 100, or continues the count operation by the counter 100 after the abnormal reload value address RVA is reset to an initial value (table start address SA or table end address EA). As a result, even if the setting of the CPU 300 or the reload value address RVA becomes an invalid address, the count operation by the counter 100 can be automatically finished so that the counter 100 can be used constantly.

The timer control circuit 120 is a circuit for controlling the count operation by the counter 100. Specifically, the timer control circuit 120 supplies a load signal LD for setting a new reload value RV to the counter 100 so that a new count-down operation is to be carried out for the first table address generation circuit 110 and the counter 100 when an interrupt request signal IRQ is supplied from the counter 100. Also, the timer control circuit 120 refers to the reload value address RVA cyclically generated by the first table address generation circuit 110 and executes control to read out a plurality of reload values RV entered to the reload value table 210 in the order of entry by.

The main memory 200 is a memory such as a RAM for storing data and programs and is directly read/written by the CPU 300. A cache memory or an external memory may be used instead of the main memory 200, but it is more preferable to employ the main memory 200 which can be accessed by the CPU 300 at a high speed. Also, the main memory 200 stores the reload value table 210 in addition to storing of general data and programs.

The reload value table 210 is a table in which the plurality of reload values RV are arranged in the order of entry determined in advance (order of reading-out). For example, a reload value RV (n−1) is stored in a reload value address RVA (n−1), a reload value RV (n) is stored in a reload value address RVA (n), and a reload value RV (n+1) is stored in a reload value address RVA (n+1). The plurality of reload values RV entered into the reload value table 210 are read out in the order of entry by the reload value address RVA cyclically generated by the first table address generation circuit 110.

FIG. 2 is a diagram illustrating wave forms of major signals of the timer circuit 10.

While the counter 100 is carrying out count-down from the reload value RV (n−1) (See FIG. 2(a)), the first table address generation circuit 110 generates the reload value address RVA (n) to be accessed next (See FIG. 2(c)). Then, when the count value CV has becomes ‘0’, that is, when a time to be measured according to the reload value RV (n−1) is reached, the counter 100 supplies the interrupt request signal IRQ to the CPU 300 and the timer control circuit 120 (See FIG. 2(b)). As a result, the CPU 300 interrupts a program currently being executed and carries out a predetermined interruption processing.

On the other hand, the timer control circuit 120 supplies the load signal LD to the first table address generation circuit 110 and the counter 100 according to the interrupt request signal IRQ (FIG. 2(e). The counter 100 refers to the table address RVA (n) according to the load signal LD and reads out the reload value RV (n) to be set next from the reload value table 210 (See FIG. 2 (d)

When the load signal LD is supplied from the timer control circuit 120, the first table address generation circuit 110 updates the current table address RVA (n) to the table address RVA (n+1) entered next (See FIG. 2(c)). On the other hand, when the load signal LD is supplied from the timer control circuit 120, the counter 100 sets a hew reload value RV (n) read out from the reload value table 210 and then, starts new count-down based on the reload value RV (n) (See FIG. 24(a)). And when the count value CV has become ‘0’, that is, when a time to be measured according to the reload value RV (n) is reached, the counter 100 supplies the interrupt request signal IRQ again to the CPU 300 and the timer control circuit 120 (See FIG. 2(b)). Thereafter, processing similar to the above is repeated.

According to the first embodiment according to the present invention, as described above, after the initial setting of the first table address generation circuit 110, the timer circuit 10 becomes possible to generate timer interruption repeatedly in a non-constant cycle independently of the processing by the CPU 300. That is, independently of the processing by the CPU 300, the plurality of reload values RV to be set in the counter 100 become possible to be switched without trouble.

### Second Embodiment

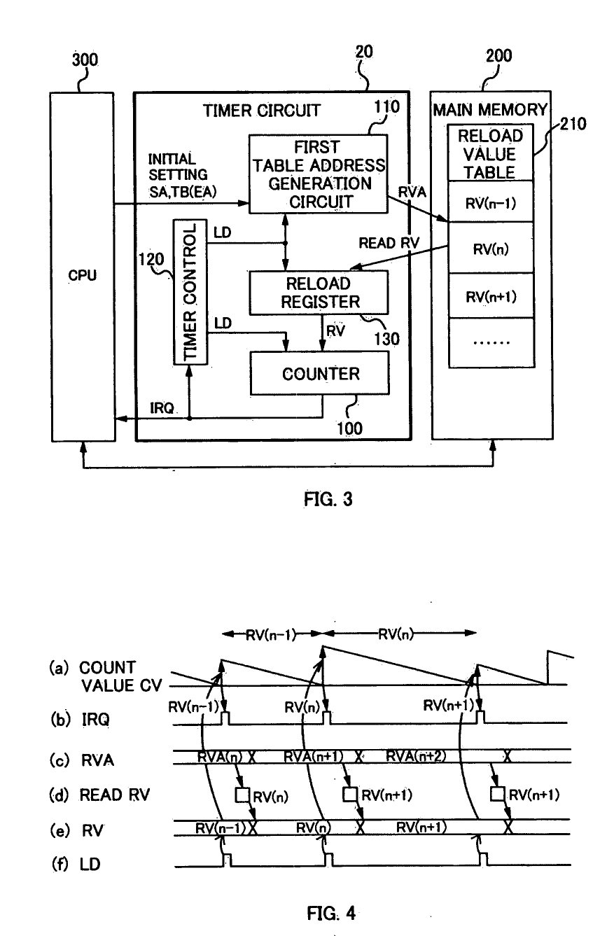

FIG. 3 is a diagram illustrating a configuration of a timer circuit 20 according to a second embodiment of the present invention.

A difference between the second embodiment and the first embodiment according to the present invention is that the timer circuit 20 is provided with a reload register 130 for temporarily storing the reload value RV read out from the main memory 200 before setting in the counter 100.

That is, in the first embodiment according to the present invention, as shown in FIG. 2(a), after the counter 100 generates the interrupt request signal IRQ, since the CPU 300 and other DMA and the like access the main memory 200 and the subsequent reload value RV can not be read out from the main memory without delay, there is a possibility that a waiting time d (overhead) might occur at the start of the count operation based on the new reload value RV. Then, by further providing the reload register 130, the timer circuit 20 attempts to solve the waiting time d.

FIG. 4 is a diagram illustrating waveforms of major signals of the timer circuit 20.

For example, in the course of counting down from the reload value, RV (n−1) in the counter 100 (See FIG. 4(a), the reload value RV (n) to be set next is stored in the reload register 130 (See FIG. 4(d)). Also, the first table address generation circuit 110 generates a reload value address RVA.(n+1) in which the reload value RV (n+1) to be set subsequent to the reload value RV (n) is stored (See FIG. 4(c)).

In this case, when the count value CV has become ‘0’, or when a time to be measured according to the reload value RV (n−1) has been reached, the counter 100 supplies the interrupt request signal IRQ to the CPU 300 and the timer control circuit 420 (See FIG. 4(b)). As a result, the CPU 300 interrupts the program currently being executed and carries out predetermined interruption processing. Also, at the point of time when the interrupt request signal IRQ is supplied, the timer control circuit 120 supplies the load signal LD to the first table address generation circuit 110, the reload register 130, and the counter 100 (See FIG. 4(f)).

At the point of time when the load signal LD is supplied, the counter 100 reads out the reload value RV (n) to be set next stored in the reload register 130 (See FIG. 4(e)) and starts new count-down from the reload value RV (n) (See FIG. 4(a)). On the other hand, the timer control circuit 120 refers to the reload value address RVA (n+1) at the time when the load signal LD is supplied (See FIG. 4(c)), reads out the reload value RV (n+1) from the reload value table 210 and updates the contents of the reload register 130 (See FIG. 4(d)). And after the contents of the reload register 130 is updated, the processing similar to the above is repeated.

In the second embodiment of the present invention, as in the first embodiment of the present invention, the counter 100 does not load the reload value RV from the main memory 200, but the counter 100 loads the reload value RV from the reload register 130. As a result, after the interrupt request signal IRQ is generated, even if the CPU 300 or the like is accessing the main memory 200, the counter 100 can read out the reload value RV to be set next from the reload register 130, and start new count-down without delay, without accessing the main memory 200.

### Third Embodiment

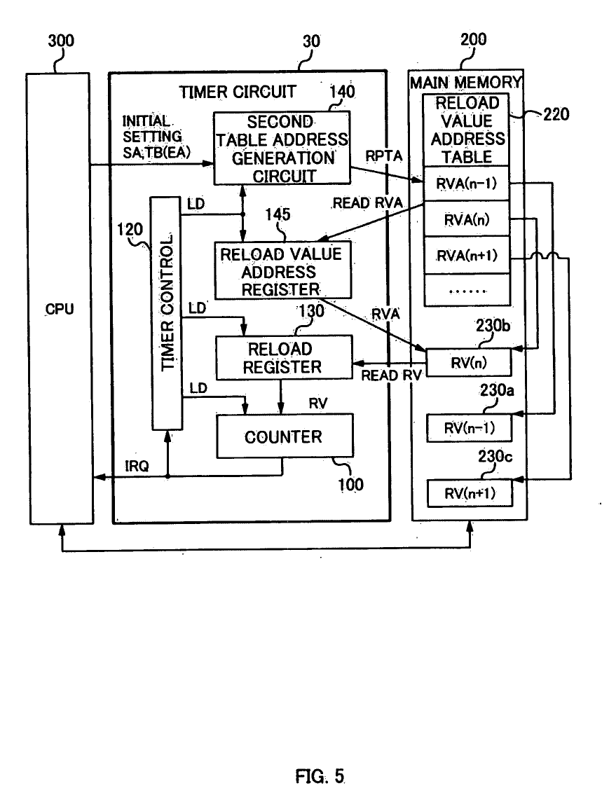

FIG. 5 is a diagram illustrating a configuration of a timer circuit 30 according to a third embodiment of the present invention.

A difference between the third embodiment and the first and second embodiments according to the present invention is that a reload value address table 220 in which a plurality of reload value addresses RVA are arranged in the predetermined order of entry (order of read-out) is provided in the main memory 200. The reload value address table 220 may be newly set in the main memory 200 for the present invention, but it is preferable that a system management table prepared in advance by a real-time OS for a microcomputer (for example, μITRON, incorporated Linux and the like) for task management etc. is utilized effectively.

In the third embodiment according to the present invention, the timer circuit 30 is provided with a second table address generation circuit 140 and a reload value address register 145 corresponding to the reload value address table 220.

The second table address generation circuit 140 cyclically generates an address RPTA of a pointer of the reload value address RVA entered in the reload value address table 220, in other words, a second table address RPTA of the reload value address table 220. The second table address generation circuit 140 is the same in function except generation of the second table address RPTA as the first table address generation circuit 110 according to the first and second embodiments of the present invention.

The reload values address register 145 is a register for storing the reload value address RVA read out from the reload value address table 220. The timer control circuit 120 refers to the reload value address RVA stored in the reload value address register 145 and reads out a desired reload value RV from reload value storage areas 230a to 230c dispersedly arranged in the main memory 200, to be stored in the reload register 130.

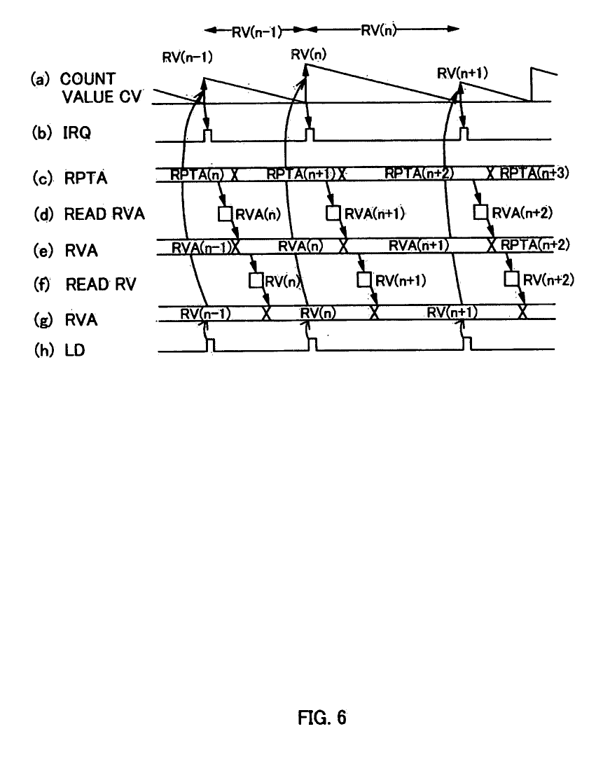

FIG. 6 is a diagram illustrating waveforms of major signals of the timer circuit 30.

While the counter 100 is carrying out count-down from the reload value RV (n−1) (See FIG. 6(a)), the reload value RV (n) to be set next is stored in the reload register 130 (See FIG. 6(f)). In the reload value address register 145, there is stored a start address (reload value address RVA (n)) of the reload value storage area 230b in which the reload value RV (n) is stored (See FIG. 6(d)). Moreover, the second table address generation circuit 140 generates a second table address RPTA (n+1) corresponding to the reload value RV (n+1) to be set next to the reload value RV (n) (See FIG. 6(c)).

In this case, the counter 100 supplies the interrupt request signal IRQ to the CPU 300 and the timer control circuit 120 when the count value CV has become ‘0’ (See FIG. 6(b)). As a result, the CPU 300 interrupts the program currently being executed. Also, at the time when the interrupt request signal IRQ is supplied, the timer control circuit 120 supplies the load signal LD to the second table address generation circuit 140, the reload value address register 145, the reload register 130 and the counter 100 (See FIG. 6(h)).

The counter 100 reads out the subsequent reload value RV (n) stored in advance in the reload register 130 at the time when the load signal LD is supplied (See FIG. 6(f)) and starts, new count-down from the reload value RV (n) without delay (See FIG. 6(a)).

On the other hand, the timer control circuit 120 refers to the second table address RPTA (n+1) at the time when the load signal LD is supplied (See FIG. 6(c)), reads out the reload value address RVA (n+1) from the reload value address table 220, and updates the contents of the reload value address register 145 (See FIG. 6(d)). Moreover, the timer control circuit 120 refers to the reload value address RVA (n+1) stored in the reload value address register 145, reads out the reload value RV (n+1) from the reload value storage area 230c, and updates the contents of the reload register 130 (See FIG. 6(f)). And after the contents of the reload register 130 is updated, the processing similar to the above is repeated.

In the third embodiment according to the present invention, as described above, the start addresses of the reload value storage areas 230a to 230c (reload value address RVA) are managed by the reload value address table 220 stored in the main memory 200. Therefore, in the third embodiment according to the present invention, even if the plurality of reload values RV are dispersedly arranged at irregular locations in random order, the count operation by the counter 100 can be carried out without trouble.

Similarly to the second embodiment according to the present invention, even if the CPU 300 and the like is accessing the main memory 200 after the interrupt request signal IRQ is generated, the counter 100 can read out the reload value RV to be set next from the reload register 130, and start new count-down, without accessing the main memory 200.

### Fourth Embodiment

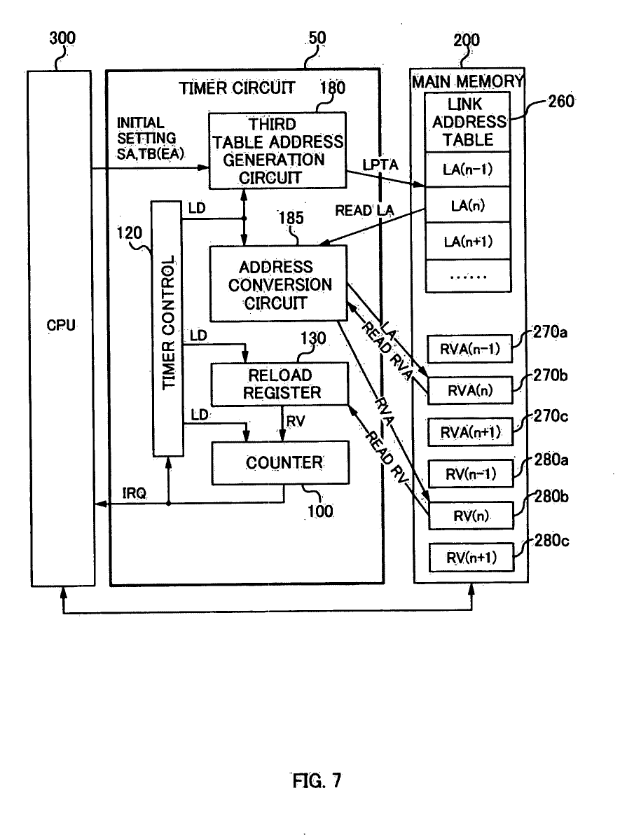

FIG. 7 is a diagram illustrating a configuration of a timer circuit 50 according to a fourth embodiment of the present invention.

A difference between the fourth embodiment and the first to third embodiments according to the present invention is assumed that reference is made with going back through a link address LA of the list structure and the reload value RV is read out in the end. Then, in the fourth embodiment according to the present invention, a link address table 260 in which a plurality of link addresses LA corresponding to link starting points of the plurality of reload value addresses RVA are arranged in the order of entry (order of read-out) is set in the main memory 200. The link address table 260 may be newly set for the present invention, but it is preferable that a system management table prepared in advance by the real-time OS for a microcomputer is effectively utilized similarly to the reload value address table 220 according to the third embodiment of the present invention.

In the fourth embodiment of the present invention, the timer circuit 40 is provided with a third table address generation circuit 180 and an address conversion circuit 185 in correspondence to the link address table 260.

The third table address generation circuit 180 cyclically generates a pointer address LPTA of a link address LA entered in the link address table 260, in other words, a third table address of the link address table 260. The third table address generation circuit 160 is the same in function except generation of the third table address LPTA as the first table address generation circuit 110 in the first and second embodiments according to the present invention.

The address conversion circuit 185 converts the link address LA read out from the link address table 260 into the start address (reload value address RVA) of the area (reload value storage areas 280a, 280b shown in FIG. 7, for example) in which the reload value RV is stored. In the case shown in FIG. 7, the address conversion circuit 185 executes address-conversion by reading out the reload value address RVA from a link destination of the link address LA (reload value address storage areas 270a, 270b shown in FIG. 7, for example). An embodiment may be so configured that the reload address RVA is obtained with referring to the link address LA twice or more.

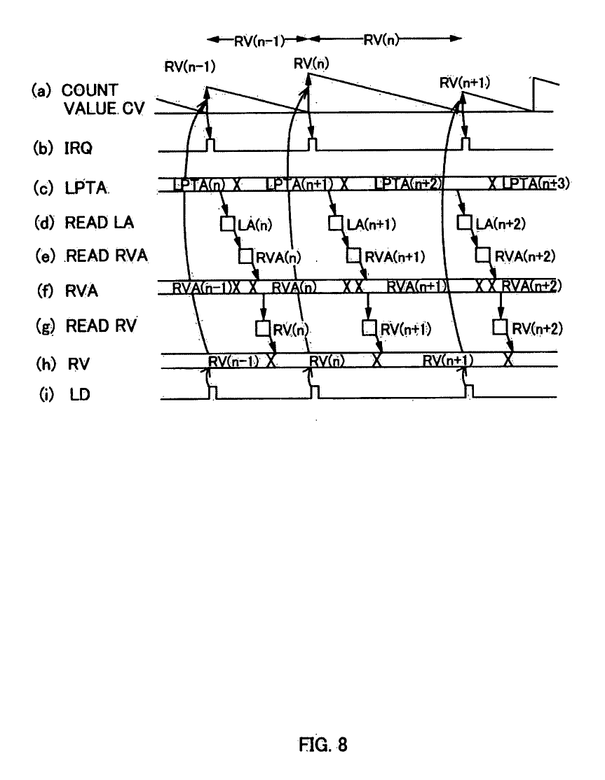

FIG. 8 is a diagram illustrating waveforms of major signals of the timer circuit 50.

While thee counter 100 is executing count-down from the reload value RV (n−1) (See FIG. 8(a)), the address conversion circuit 185 is supplied: with a link address LA (n) read out from the link address table 260 (See FIG. 8(d)); and moreover with a reload value address RVA (n) read out from the reload value address storage area 270b (See FIG. 8(e)). And the reload register 130 stores the reload value RV (n) to be set next with referring to the reload value address RVA (n) (See FIG. 8(e)). The third table address generation circuit 180 generates a third table address LPTA (n+1) for the reload value RV (n+1) to be set further subsequent to the reload value RV (n) (See FIG. 8(c)).

In this case, when the count value CV has become ‘0’, or when a time to be measured according to the reload value RV (n−1) is reached, the counter 100 supplies the interrupt request signal IRQ to the CPU 300 and the timer control circuit 120 (See FIG. 8(b)). As a result, the CPU 300 interrupts the program currently being executed and carries out the predetermined interruption processing. Also, the timer control circuit 120 supplies the load signal LD without delay to the third table address generation circuit 180, the address conversion circuit 185, the reload register 130 and the counter 100 at the time when the interrupt request signal IRQ is supplied (See FIG. 8(i)).

At the time when the load signal LD is supplied, the counter 100 reads out the next reload value RV (n) stored in the reload register 130 in advance (See FIG. 8(i)) and starts new count-down from the reload value RV (n) (See FIG. 8(a)).

The fourth embodiment according to the present invention, as described above, effectively functions when the link address LA in the list structure is followed in the main memory 200 to read out the reload value RV in the end.

### Fifth Embodiment

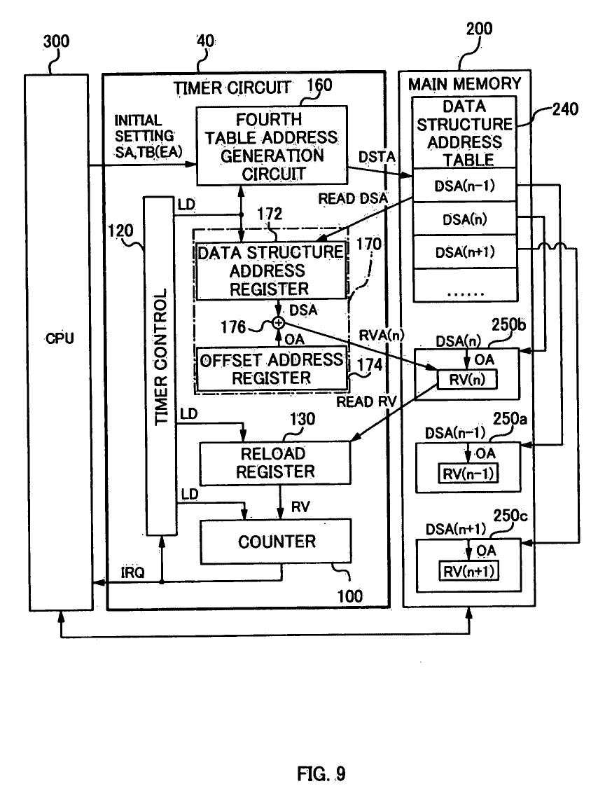

FIG. 9 is a diagram illustrating configuration of a timer circuit 40 according to a fifth embodiment of the present invention.

A difference between the fifth embodiment and the first to fourth embodiments according to the present invention, particularly the fourth embodiment according to the present invention, that the reload value RV is included as an element of a data structure (data structures 250a to 250c shown in FIG. 7, for example) such as a task control block TCB or the like under a multi-task OS environment. The data structures are dispersedly arranged at irregular locations in random order in the main memory 200 similarly to the reload value storage areas 230a to 230c according to the third embodiment of the present invention in actual use.

Then, in the fifth embodiment according to the present invention, a data structure address table 240 in which the start addresses of the data structures 250a to 250c (data structure address DSA) are arranged in the order of entry (order of read-out) is set in the main memory 200. Since the data structure address DSA is one embodiment of the link address of the reload value address RVA, the data structure address table 240 is one embodiment of the link address table 260. Also, the data structure address table 240 may be newly set for the present invention but it is preferable that a system management table prepared in advance the real-time OS for a microcomputer is effectively utilized similarly to the reload value address table 220 according to the third embodiment of the present invention.

In the fifth embodiment according to the present invention, the timer circuit 40 is provided with a fourth table address generation circuit 160, a data structure address register 172, an offset address register 174, and an offset adder 176 corresponding to the data structure address table 240.

The fourth table address generation circuit 160 cyclically generates a pointer address DSTA of the data structure address DSA entered in the data structure address table 240, in other words, the fourth table address DSTA of the data structure address table 240. The fourth table address generation circuit 160 is one mode of the third table address generation circuit 180 according to the third embodiment of the present invention.

The address conversion circuit 170 includes the data structure address register 172, the offset address register 174, and the offset adder 176, and the address conversion circuit 170 reads out the data structure address DSA from the data structure address table 240 stored in the main memory 200 and converts the read-out data structure address DSA into the reload value address RVA corresponding thereto.

The data structure address register 172 is a register for storing a data structure address DSA read out from the data structure address table 240.

The offset address register 174 is a register for storing relative address from the start address of each of the data structures 250a to 250c (data structure address DSA) to the storage location of the reload value RV (reload value address RVA), that is, an offset address OA. In this embodiment, the offset address OA is a uniform value in the data structures 250a to 250c.

The offset adder 176 generates the reload value address RVA by adding the data structure address DSA read out from the data structure address table 240 and the offset address OA stored in the offset address register 174. Therefore, the timer control circuit 120 refers to the reload value address RVA outputted from the offset adder 175, reads out the reload value RV from the data structures 250a to 250c, to be stored in the reload register 130.

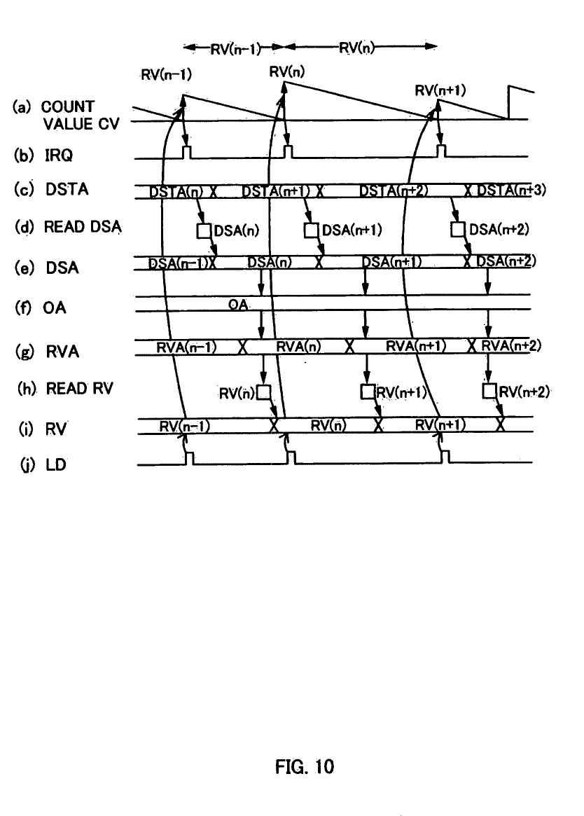

FIG. 10 is a diagram illustrating waveforms of major signals of the timer circuit 40.

While the counter 100 is carrying out count-down from the reload value RV (n−1) included in the data structure 250a (See FIG. 10(a)), the reload value RV (n) to be set next is stored in the reload register 130 (See FIG. 10(h). Also, in the data structure address register 172, the start address (data structure address) DSA (n) of the data structure 250b including the reload value RV (n) to be set next is stored (See FIG. 10(d)). The fourth table address generation circuit 160 generates a fourth table address DSTA (n+1) for storing a pointer of the data structure 250c including the reload value RV (n+1) to be set further next (See FIG. 10(c)).

In this case, when the count value CV has become ‘0’, that is, when a time to be measured according to the reload value RV (n−1) is reached, the counter 100 supplies the interrupt request signal IRQ to the CPU 300 and the timer control circuit 120 (See. FIG. 10(b)). As a result, the CPU 300 interrupts the program currently being executed. Also, at the time when the interrupt request signal IRQ is supplied, the timer control circuit 120 supplies the load signal LD to the fourth table address generation circuit 160, the data structure address register 172, the reload register 130 and the counter 100 (See FIG. 10(j)).

At the time when the load signal LD is supplied, the counter 100 reads out the subsequent reload value RV (n) stored in advance in the reload register 130 (See FIG. 10 (i)) and starts new count-down from the reload value RV (n) without delay (See FIG. 10(a)).

On the other hand, the data structure address register 172 refers to the table address DSTA (n+1) at the time when the load signal LD is supplied (See FIG. 10(c)), reads out the data structure address DSA (n+1) from the data structure address table 240 in the main memory 200, and updates the contents (See FIG. 10(d)).

Also, the reload register 130 reads out and stores the reload value RV (n+1) from the data structure 250c (See FIG. 10(h)) based on the reload value address RVA (n+1) generated by adding the data structure address DSA (n+1) stored in the data structure address register 172 and the offset address OA stored in the offset address register 174 by the offset adder 176 (See FIG. 100(g)).

In the fifth embodiment according to the present invention, as described above, even if the reload value RV is stored in the main memory 200 as one element of the data structure, the count operation by the counter 100 can be carried out without trouble. Also, assuming that under the real-time OS environment, the above-mentioned data structure is a task control block TCB and a reload value RV included in the task control block TCB is a time slice value (applicable to processing priority) allocated to a task to be managed of the task control block TCB, the real-time/multi-task system can be easily constructed. With the real-time/multi-task system based on the fourth embodiment according to the present invention, overhead time required for task switching (dispatch) can be reduced.

### Other Embodiments

The above embodiments of the present invention are simply for facilitating the understanding of the present invention and are not in any way to be construed as limiting the present invention. The present invention may variously be changed or altered without departing from its spirit and encompass equivalents thereof.

For example, the timer circuits 10, 20, 30, 40, and 50 can be used in various ways for generating various timing in a signal processing circuit such as a microcomputer, DSP and the like in addition to being used for the above-mentioned timer interruption. For example, they can be used as a one-shot timer, on-delay timer, off-delay timer and the like. The timer circuits 10, 20, 30, 40, and 50 can be also used for an arbitrary pulse generation circuit including a PWM (Pulse Width Modulation).

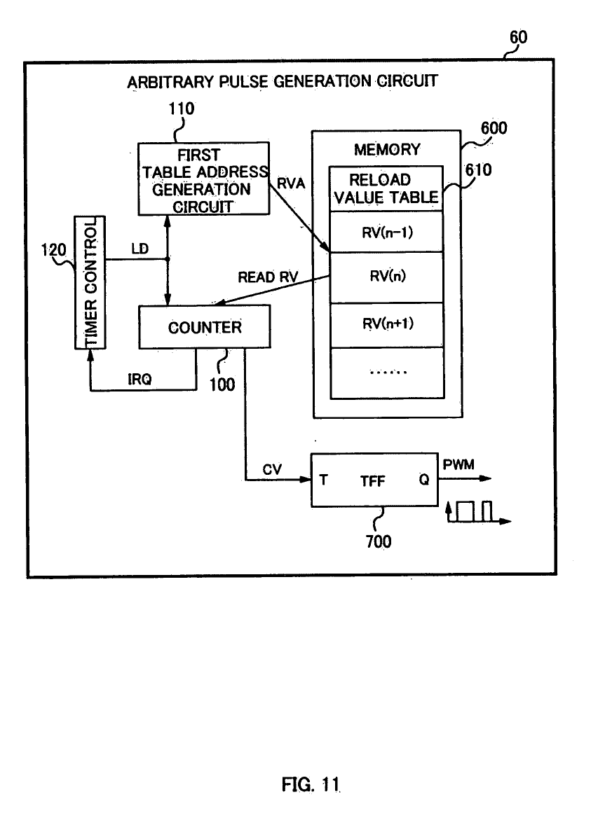

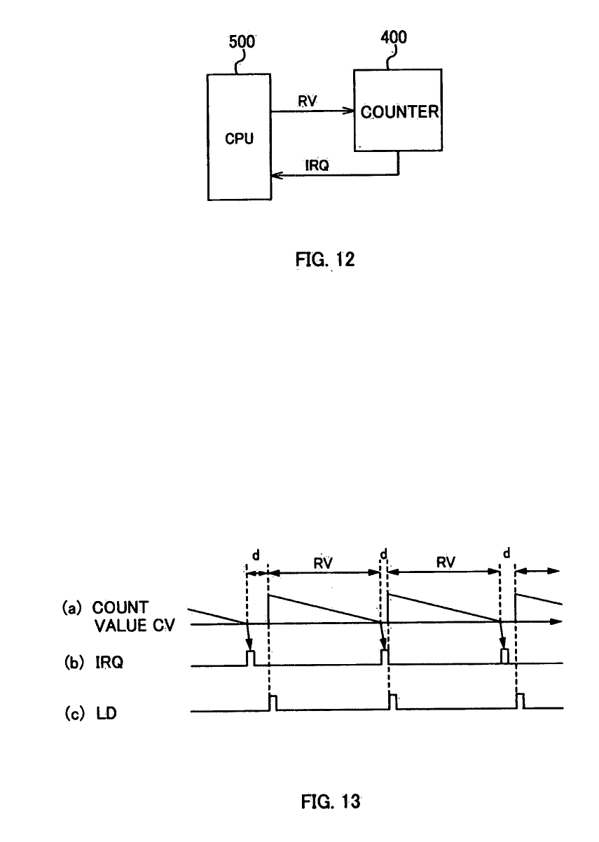

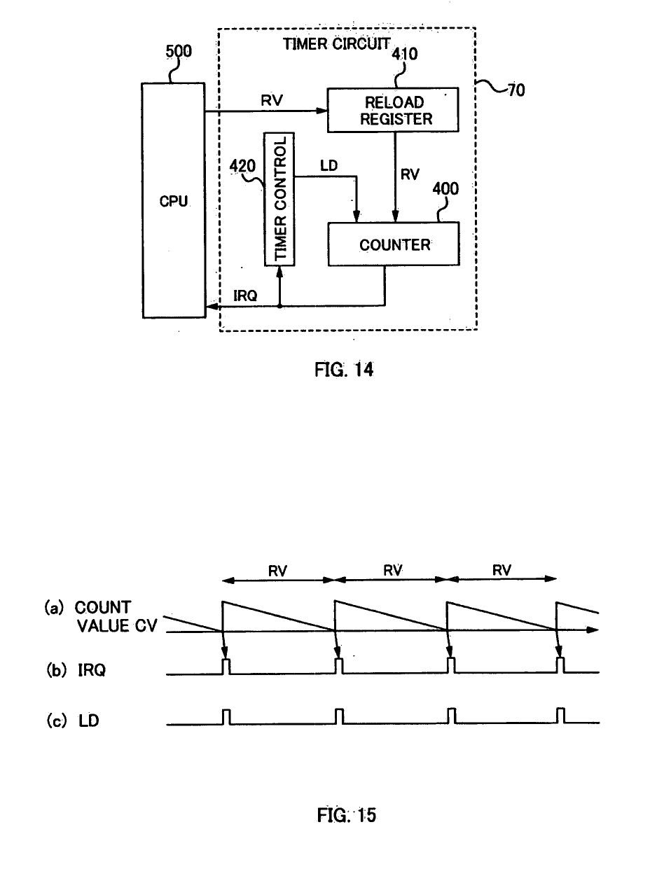

FIG. 11 is a diagram illustrating a configuration of an arbitrary pulse generation circuit 60 when the timer circuit 10 according to the first embodiment of the present invention is used.

A difference between the arbitrary pulse generation circuit 60 and the timer circuit 10 connected to the CPU 300 is that a T flip-flop 700 (toggle type) is driven according to an output (count value CV) of the counter 100 in the arbitrary pulse generation circuit 60. In a memory 600, similarly to the first embodiment according to the present invention, there is set a reload value table 610 in which a plurality of reload values RV are entered in a predetermined order of read-out. Therefore, the counter 100 repeatedly carries out down-count in a non-constant cycle based on the reload value RV read out in the order of entry from the reload value table 610.

As mentioned above, since the arbitrary pulse generation circuit 60 inputs the count value CV of the counter 100 in which a plurality of different reload values RV are reset, into the T flip-flop 700, a pulse width of a pulse signal can be arbitrarily changed.

1. A timer circuit for setting a reload value according to a time to be measured and carrying out count operation based on the set reload value, comprising:
a memory configured to store a plurality of reload values;
a reload value address generation circuit configured to generate a reload value address indicating a storage location of each of the plurality of reload values in the memory;
a counter configured to carry out count operation based on the reload value read out from the memory referring to a reload value address generated in the reload value address generation circuit; and
a timer control circuit configured to control
update of tile reload value address in the reload value address generation circuit and
read-out of the reload value from the memory to the counter.

2. A signal processing circuit comprising:
a timer circuit including
a memory configured to store a plurality of reload values according to a time to be measured,
a reload value address generation circuit configured to generate a reload value address indicating a storage location of each of the plurality of reload values in the memory,
a reload register configured to store the reload value read out from the memory referring to a reload value address generated in the reload value address generation circuit,
a counter configured to carry out count operation based on the reload value stored in the reload register and output a status flag signal when a count value has reached a time corresponding to the reload value, and
a timer control circuit configured to control update of the reload value address in the reload value address generation circuit and read-out of the reload value from the memory to the counter; and
a processor configured to carry out a predetermined processing according to the status flag signal output from the counter.

3. The signal processing circuit of claim 2, wherein
the memory is configured to store a reload value table in which a plurality of the reload values are arranged; and
the reload value address generation circuit is configured to generate a first table address of the reload value table.

4. The signal processing circuit of claim 2, wherein
the memory is configured to store a reload value address table in which a plurality of the reload value addresses are arranged, and wherein
the reload value address generation circuit includes:
a second table address generation circuit configured to generate a second table address of the reload value address table; and
a reload value address register configured to store the read-out reload value address referring to the second table address generated in the second table address generation circuit, and wherein
the reload register is configured to store the reload value based on the reload value address stored in the reload value address register.

5. The signal processing circuit of claim 2, wherein
the memory is configured to store a link address table in which a link address of the reload value address is arranged, and wherein
the reload value address generation circuit includes:
a third table address generation circuit configured to generate a third table address of the link address table; and
an address conversion circuit configured to read out the link address referring to the third table address generated in the third table address generation circuit, to be converted into the reload value address corresponding to the link address.

6. The signal processing circuit of claim 5, wherein
the memory is configured to store a plurality of data structures including the plurality of reload values, respectively;
the link address table includes a table in which a data structure address indicating a storage location of each of the plurality of data structures in the memory is arranged; and
the address conversion circuit includes a data structure address register configured to store the data structure address read out from the link address table.

7. The signal processing circuit of claim 6, wherein
the address conversion circuit
includes an offset address register configured to store an offset address indicating a storage location of the reload value in the data structure, and
is configured to obtain the reload value address by adding the data structure address and the offset address.

8. The signal processing circuit of claim 6, wherein
the data structure includes a task control block; and
the reload value included in the data structure includes a time slice value allocated to a task to be managed of the task control block.

9. The signal processing circuit of claim 7, wherein
the data structure includes a task control block; and
the reload value included in the data structure includes a time slice value allocated to a task to be managed of said task control block.
